(19) United States
(12) Patent Application Publication
(10) Pub. No.: US 2007/0247268 A1
(43) Pub. Date: Oct. 25, 2007

(54) Inductor element and method for production thereof, and semiconductor module with inductor element

(76) Inventors: Yoichi Oya, Kanagawa (JP); Shusaku Yanagawa, Kanagawa (JP); Shuichi Oka, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(21) Appl. No.: 11/711,521

(22) Filed: Feb. 27, 2007

(30) Foreign Application Priority Data
Mar. 17, 2006 (JP) 2006-073837

(51) Int. Cl. H01F 5/00

(52) U.S. Cl. 336/200; 29/602.1

(57) ABSTRACT

An inductor element includes a substrate of magnetic material, a coil, and a layer of magnetic material. The coil of conductive material is formed on the substrate. The layer of magnetic material is so formed by aerosol deposition as to enclose the coil on the substrate of magnetic material.

### CROSS REFERENCES TO RELATED APPLICATIONS

The present invention contains subject matter related to Japanese Patent Application JP 2006-073837 filed with the Japanese Patent Office on Mar. 17, 2006, the entire contents of which being incorporated herein by reference.

### BACKGROUND OF THE INVENTION

1. Field of the Invention

The present invention relates to an electronic component and, more particularly, to a small-sized inductor element having a large inductance and a high quality factor and a method for production thereof, and also to a semiconductor module with the inductor element.

2. Description of the Related Art

Inductors fall under several categories according to their structure, such as wire-wound coil, laminated coil, and thin-film coil. The laminated coil is composed of layers of ferrite or ceramic material placed one over another, each layer having a conductor pattern printed thereon, such that all the printed conductor patterns are connected to each other by via contacts. The thin-film coil is a spiral planar coil held between layers of ferrite or ceramic material. They are divided further into two classes, such as closed magnetic circuit and open magnetic circuit, depending on whether or not the coil is isolated from the surrounding. In the closed magnetic circuit, the coil is isolated from the surrounding, while the coil is not isolated from the surrounding in the open magnetic circuit.

An inductor as a discrete component has a wound coil structure, with or without an iron core inserted therein. The inductor of this type is large in size and hence prevents the module with it from miniaturization.

There is known a new module structure to achieve miniaturization, which is composed of an LTCC (Low Temperature Co-fired Ceramic) substrate with built-in inductors and capacitors and an LSI mounted thereon. There is also known another new module called IPD (Integrated Passive Device) which is composed of only passive components.

A description is given below of the related art technology for the inductor of thin-film type with a high-permeability material.

Japanese Patent Laid-open No. Sho 63-283004 (page 2, lower left column, lines 8 to 14; page 2, lower right column, lines 10 to 20; page 3, upper right column, lines 8 to 20; page 3, lower left column, lines 3 to 15; and page 3, lower right column, lines 1 to 7, FIG. 2) referred to as Patent Document 1 hereinafter mentions “Planar inductor and production thereof” as follows.

According to the invention disclosed in Patent Document 1, the planar inductor is composed of a coil and two ferrite plating layers holding it between them using wet process. Its production involves the steps of coating a substrate with a ferrite plating layer, forming a conducting coil thereon, and forming another ferrite plating layer thereon.

This manufacturing process gives a high-performance planar inductor having a high inductance and good frequency characteristics because the conducting coil is completely enclosed by ferrite layers, with magnetic resistance greatly reduced and capacitance almost eliminated. The planar inductor with its flat coil entirely enclosed by ferrite plating films does not leak the magnetic flux which causes cross-talk. Therefore, it is suitable for high-density mounting and high-frequency band, and it will find its most appropriate use in controlling electromagnetic noise.

The conducting coil in the form of thin film may be formed from any of well-known metals or alloys (such as Cu, Ag, Au, Pt, Pd, Ag-Pd, and Sn-Pb) by electrolytic or electroless wet plating, vapor deposition, sputtering, or screen printing applicable to thermosetting conductive paste. The pattern of the coil and its leads may be formed by spin coating with a photoresist and ensuing photoetching or by screen printing with a conductive paste.

Some examples of the existing planar inductor is shown in FIG. 11.

FIG. 11A is a reproduction of FIG. 1 in Patent Document 1. It shows the structure in section of the planar inductor held between ferrite magnetic cores, which conforms to one embodiment of the invention disclosed in Patent Document 1.

This planar inductor is produced as follows. A substrate 67 of glass plate cleaned with chromic acid mixture is entirely coated with a ferrite layer 68 by wet plating. On the ferrite layer 68 is formed a meandering coil 69 by screen printing with thermosetting Ag paste and ensuing baking at 150° C. or under. The leads of the coil are masked with a solvent-soluble resist which is inert to ferrite plating, and the entire surface is coated again with a ferrite layer 70 by wet plating in the same way as mentioned above. Finally, the mask on the leads is removed by a solvent. Thus there is obtained a planar inductor with ferrite magnetic cores on both sides.

According to Patent Document 1, the planar inductor held between ferrite magnetic cores is constructed such that a flat coil is held between ferrite layers formed by wet plating. Consequently, it is very simple in structure, superior in performance (inductance and frequency characteristics), and low in price.

Japanese Patent Laid-open No. Hei 7-22242 (paragraphs 0005, 0007, 0008, 0013, and 0014, FIGS. 1 and 2) referred to as Patent Document 2 hereinafter mentions “Planar inductor and production thereof” as follows.

According to the invention disclosed in Patent Document 2, the planar inductor is composed of a first magnetic body substrate, an insulating non-magnetic film, a conducting coil, and a second magnetic body, which are sequentially formed one over another.

FIG. 11B is a reproduction of FIG. 1 in Patent Document 2. It schematically shows the structure in plan and in section of the planar inductor, which conforms to one embodiment of the invention disclosed in Patent Document 2. FIG. 11C is a reproduction of FIG. 2 in Patent Document 2. It shows the process for producing the planar inductor, which conforms to one embodiment of the invention disclosed in Patent Document 2.

The planar inductor shown in FIG. 11B is composed of a first magnetic body 61 of NiZn ferrite serving as a substrate, an Al₂O₃ film 62 serving as a spacer, a conductor 63 of meandering coil, a second magnetic body 64 of NiZn ferrite, and electrodes 65. The following procedure is employed to produce the planar inductor according to one embodiment of the invention disclosed in Patent Document 2. In the first step shown in part (a) of FIG. 11C, the NiZn ferrite substrate 61 as a first magnetic body is coated by sputtering with an Al₂O₃ film 62 which is an insulating non-magnetic body. This Al₂O₃ film 62 serves as a spacer between a first magnetic body and a second magnetic body. In the second step shown in part (b) of FIG. 11C, the Al₂O₃ film 62 has a Cu coil conductor 63 formed thereon by plating as follows. The Al₂O₃ film 62 is coated by sputtering with a Cu film which serves as a plating electrode with an optional Ti film placed between them for improved adhesion. The Cu film undergoes photolithography for a coil pattern and then undergoes electrolytic plating so that a coil of Cu film is formed. The photoresist in coil pattern is removed and the Cu film thereunder (which served as a plating electrode) is removed by etching. In the third step shown in part (c) of FIG. 11C, the coil conductor 63 is covered with a paste of NiZn ferrite fine particles. The uniformly applied paste is baked in an electric furnace to form the NiZn ferrite layer 64 as a second magnetic body. In this manner there is obtained the desired planar inductor.

In the above-mentioned procedure, sputtering to form the conductor may be replaced by electrolytic plating, ion-plating, or vapor deposition. Cu used for the conductor may be replaced by any low-resistance substance such as Al, Ag, Au, and alloys thereof. Also, Al₂O₃ as the insulating non-magnetic material may be replaced by AlN or SiN.

The planar inductor according to the invention disclosed in Patent Document 2 is characterized by outstanding frequency characteristics, high quality factor, and adaptability to mass production because it is composed of a magnetic substrate, an insulating non-magnetic layer, a conducting coil, and an insulating magnetic material, which are sequentially formed one over another. Being small and thin, it will contribute to the size and weight reduction of electronic devices.

Japanese Patent Laid-open No. Hei 5-121240 (paragraphs 0007, and 0015 to 00224, FIG. 1) referred to as Patent Document 3 hereinafter mentions “Inductance component and production thereof” as follows:

According to the invention disclosed in Patent Document 3, the inductance component is composed of a ferrite substrate, a coil of laminate structure with conductors separated by insulating layers, and a ferrite magnetic layer that passes the magnetic flux emanating from the coil, which are placed on top of the other.

FIG. 11D is a reproduction of FIG. 1 in Patent Document 3. It shows the structure in section of the inductance component, which conforms to one embodiment of the invention disclosed in Patent Document 3. The inductance component is composed of a ferrite substrate 71, a ferrite magnetic layer 72, an insulating layer 73, and a spiral conductor 74. The conductor 74 in the insulating layer 73 constitutes the coil, which is covered by the ferrite magnetic layer 72. Incidentally, the spiral conductor 74 may be composed of any number of layers.

The ferrite substrate 71 may be selected from sintered substrates of NiZn ferrite, MnZn ferrite, and NiZnCu ferrite, which have the spinel structure and good soft magnetic characteristics.

The ferrite magnetic layer 72 may be selected from various ferrites (and mixtures thereof) of any other spinel structure than MnZn ferrite, NiZn ferrite, and NiZnCu ferrite. It differs from the ferrite substrate 71 in processing, structure, and magnetic characteristics.

The conductor 74 may be formed by printing from such metal as silver, copper, gold, silver-palladium alloy, and silver-platinum alloy. Such metals are often used to form a conductor. Selection depends on the resistance of the conductor and the melting point of the metal. For a low coil resistance, silver or copper is selected. However, these metals are sintered at a comparatively low temperature which is not sufficient for the ferrite magnetic layer 72 to be sintered completely. This drawback is overcome by incorporating the ferrite magnetic layer 72 with a sintering aid or a binder such as glass.

The inductance component having a ferrite substrate 71, ferrite magnetic layer 72, insulating layer 73, and coil formed of the conductor 74 is a thin or small one that permits the ferrite sintered body to fully exhibit its characteristic properties. Moreover, it possesses outstanding electrical properties despite its thin or small size because its magnetic circuit is composed mainly of ferrite sintered body. These features are important for any electrical module such as DC-DC converter with thick film resistors or capacitors formed on a ceramic substrate, thereby enhancing the features according to an embodiment of the Patent Document 3. Moreover, the inductance component according to an embodiment of the Patent Document 3 can be fabricated together with the wiring substrate for high mounting density and high reliability.

The coil may be of solenoid type or planar spiral type wound several times on the same plane. The former favors volume reduction and the latter favors thickness reduction.

Japanese Patent Laid-open No. Hei 11-168010 (paragraph 0016, 0021, 0022, 0031, 0032, and 0042, FIG. 1) referred to as Patent Document 4 hereinafter mentions “Microinductor” as follows.

According to the invention disclosed in Patent Document 4, the microinductor is composed of a substrate with a surface roughness Ra of 30 to 6000 A, a coil formed thereon by plating, and a magnetic section constituting a closed magnetic circuit.

FIG. 11E is a reproduction of FIG. 1 in Patent Document 4. Parts (a) and (b) of FIG. 11E are perspective and sectional views, respectively, showing the microinductor pertaining to the first embodiment of the invention disclosed in Patent Document 4.

There is shown a ferrite substrate 81a with a surface roughness of 50 Å as shown in the parts (a) and (b) of FIG. 11E. On this substrate is a coil 82a formed by copper plating. The coil 82a is a spiral strip of copper plating layer on the substrate 81a. On the substrate 81a is also a ferrite core 83a which is formed such that it touches the substrate 81a at the center of the coil 82a and both sides of the coil 82a but it is separated from the coil 82a. Thus, the substrate 81a and the core 83a constitute the closed magnetic circuit.

The microinductor mentioned above offers the advantage that the substrate 81a with an adequately controlled surface roughness provides good adhesion between the substrate 81a and the coil 82a formed thereon by plating. Good adhesion permits the coil 82a to be formed thick (say, 30 to 200 μm). The resulting coil 82a of plated copper strip has a large sectional area perpendicular to the direction of current flow and hence has a low DC resistance. Consequently, the microinductor can be applied to high-output high-efficiency converters. In addition, the coil 82a formed by plating can have any dimension, especially thickness, tailored to the intended use. This contributes to an inductor which is small in size and yet has a high efficiency with a reduced leakage of magnetic flux.

The substrate with a controlled surface roughness Ra permits the coil of copper plating layer to be formed in the thickness of 30 to 200 μm, and the resulting coil has a low DC resistance. Incidentally, the copper plating layer for the coil should preferably have a thickness of 50 to 150 μm.

The coil should be constructed such that the line width is 50 to 200 μm (preferably 80 to 150 μm) and the line gap is 5 to 100 μm (preferably 20 to 50 μm) and the number of turns is 3 to 10 (preferably 3 to 5).

According to the invention disclosed in Patent Document 4, the coil of plating layer can be made as thick as desirable owing to the adequately controlled surface roughness of the substrate. The resulting coil has a low DC resistance and this makes the microinductor applicable to high-output high-efficiency converters.

Japanese Patent Laid-open No. Hei 6-252350 (paragraph 0012 and 0013, FIG. 1) referred to as Patent Document 5 hereinafter mentions “Microinductor and production thereof” as follows.

FIG. 11F is a reproduction of FIG. 1(a) in Patent Document 5. It is a plan view showing the microinductor pertaining to the first and second embodiments of the invention disclosed in Patent Document 5.

The invention disclosed in Patent Document 5 provides a microinductor with a high-performance coil and a method for production thereof. As shown in FIG. 11F, the microinductor is composed of a substrate, a patterned conductor formed thereon, and an insulating soft magnetic material covering the entire surface. The substrate 90a may be formed from the insulating soft magnetic material 90 of garnet structure containing yttrium-iron garnet or rare earth elements and transition metal elements.

Alternatively, the substrate 90b is the insulating soft magnetic material 90 constituting the surface layer. The microconductor 91 has the lands 91a formed on the substrate. The insulating soft magnetic material 92 covers the entire surface of the microconductor 91 except for the lands 91a.

JFE Technical Report (No. 8, Jun. 2005, p. 57 to 59, p. 57 (1. Introduction, 2. Structure of planar inductor), and p. 59 (5. Epilogue)) referred to as Non-Patent Document 1 hereinafter mentions “Extremely thin inductor for DC-DC converter” as follows, in relation to the extremely thin inductor for DC-DC converter (0.6 mm thick) as planar inductor hereinafter.

FIG. 12 is a reproduction of FIG. 1 in Non-Patent Document 1, which schematically shows the structure of the planar inductor.

The planar inductor is a copper spiral coil held between two ferrite layers with the gap between adjacent conductors filled (upper ferrite layer and lower ferrite layer) with a magnetic material which is a mixture of ferrite powder and resin. It is known that the closed magnetic circuit of such special structure makes the conductor decrease in eddy current loss. The coil is connected to external electrodes through two through-holes with copper plating on their inside made in the lower ferrite layer, as indicated by hatched circles in FIG. 12.

### SUMMARY OF THE INVENTION

High-performance electronic devices demand a small-size inductor having large values of inductance and quality factor.

According to the existing technology, the built-in inductor on the LTCC substrate or the inductor as a constituent of the IDP has the following disadvantages: low inductance due to the coil formed from the limited space, for example, part of the multi-layer wiring layer; low quality factor due to the high permittivity of the substrate for the inductor where a quality factor is an indicator of low loss; and limitations in selection of metallic material and thickness due to the necessity of forming the coil in conformity with the same specifications as established for the wiring pattern on the substrate.

The present invention was completed to address the above-mentioned problems. Thus, it is a desire of the present invention to provide a small-sized inductor element having a large inductance and a high quality factor and a method for production thereof, and also to a semiconductor module with the inductor element.

The first embodiment of the present invention is directed to an inductor element which includes a substrate of magnetic material, a coil of conductive material formed on the substrate, and a layer of magnetic material which is so formed by aerosol deposition as to enclose the coil on the substrate.

The second embodiment of the present invention is directed to a semiconductor module which includes the inductor element defined above and a semiconductor chip electrically connected thereto.

The third embodiment of the present invention is directed to a method for producing an inductor element which includes the steps of forming a coil from a conductive material on a substrate of magnetic material and forming by aerosol deposition a layer of magnetic material so as to enclose the coil on the substrate.

The present invention provides an inductor element which is thin and small and yet has a high inductance and a high quality factor on account of a layer of magnetic material with a compact structure which is so formed by aerosol deposition as to enclose a coil with a desired sectional area on a substrate of magnetic material. The present invention also provides a thin, small-sized, high-performance semiconductor module which is composed of the inductor element and a semiconductor chip electrically connected thereto. The present invention also provides a method for producing a cheap, high-performance inductor element by so forming a layer of magnetic material by aerosol deposition as to enclose a coil on a substrate of magnetic material. Aerosol deposition gives a layer of magnetic material with a compact structure.

### BRIEF DESCRIPTION OF THE DRAWINGS

FIGS. 1A to 1C are schematic diagrams showing the structure of the inductor element pertaining to the embodiment of the present invention. FIG. 1A is a plan view. FIG. 1B is a sectional view taken along the line W-W. FIG. 1C is a plan view showing the pattern of the inner layer;

FIGS. 2A to 2D are schematic diagrams showing the inductor element on which devices are mounted, as above. FIG. 2A is a plan view. FIG. 2B is a sectional view taken along the line W-W. FIG. 2C is a bottom view of the device. FIG. 2D is a perspective view;

FIG. 3 is a flow sheet showing the steps of producing the inductor element and the semiconductor module, as above;

FIG. 4 is a flow sheet showing the film-forming steps by aerosol deposition, as above;

FIGS. 5A to 5F are diagrams showing the first half of the steps of producing the inductor element and the semiconductor module, as above;

FIGS. 6A to 6E are diagrams showing the second half of the steps of producing the inductor element and the semiconductor module, as above;

FIG. 7 is a graph showing the relation between the thickness and the inductance of the ferrite layer of the inductor element, as above;

FIGS. 8A and 8B are diagrams showing the structure of the module having the inductor element connected to the lead frame. FIG. 8A is a plan view. FIG. 8B is a sectional view taken along the line Z-Z, as above;

FIGS. 9A and 9B are diagrams showing the structure of the module having the inductor element connected to the interposer substrate. FIG. 9A is a plan view. FIG. 9B is a sectional view taken along the line Y-Y, as above;

FIGS. 10A and 10B are diagrams showing the structure of the module having the inductor element connected to the interposer substrate. FIG. 10A is a plan view. FIG. 10B is a sectional view taken along the line X-X, as above;

FIGs. 11A to 11F are diagrams showing the structure of the inductor according to the existing technology; and

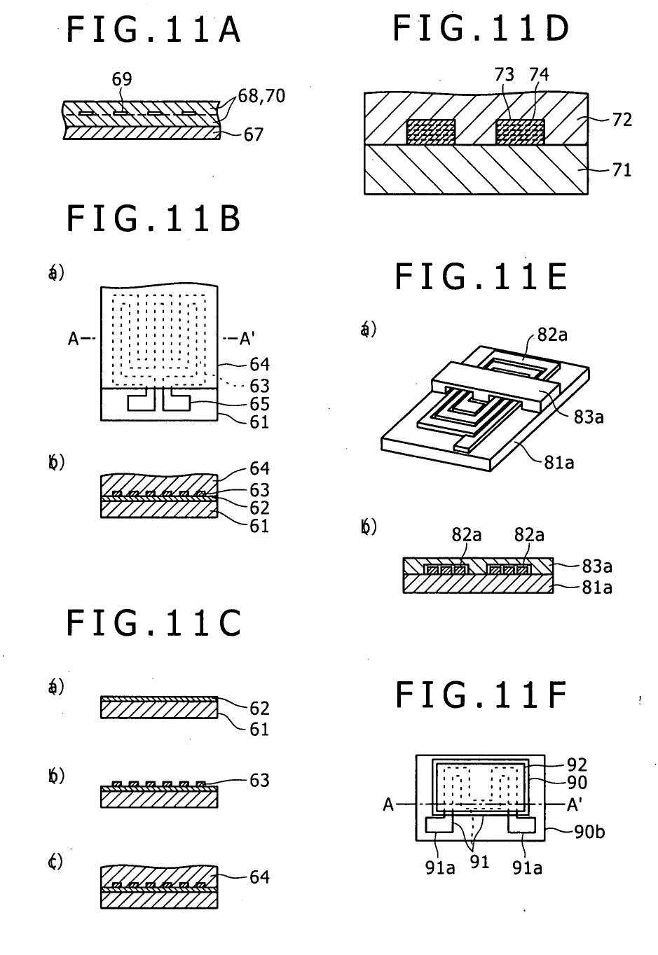

FIG. 12 is a diagram showing the structure of the planar inductor, as above.

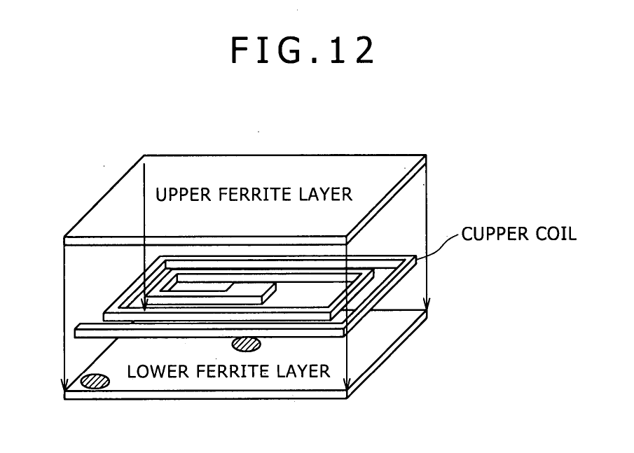

### DETAILED DESCRIPTION OF THE PREFERRED EMBODIMENTS

The inductor element according to an embodiment of the present invention should have both the substrate of magnetic material and the layer of magnetic material formed from a high-permeability material, so that the coil is embedded in the high-permeability material. This structure permits the inductor element to exhibit a high inductance.

Both the substrate of magnetic material and the layer of magnetic material should preferably be formed from ferrite. Being formed from ferrite by aerosol deposition, the layer of magnetic material, which is thicker than 50 μm, has a compact structure, so that the inductor element is thin and small and yet has a high inductance.

The coil should preferably be a planar coil thicker than 50 μm, so that it has a large sectional area that permits a large allowable current (maximum current) to flow through the inductor element.

The inductor element should have terminals connected to the ends of the coil on the outside of the layer of magnetic material, so that a desired device is electrically connected to the coil embedded in the layer of magnetic material through the terminals. This structure reduces the distance between the inductor element and the desired device.

The substrate of magnetic material should have a titanium thin film and a copper thin film which are sequentially formed thereon, and the conductor for the coil is formed by plating on the copper thin film. The coil formed in this way firmly adheres to the surface of the substrate of magnetic material.

The semiconductor module according to the present invention should be constructed such that the ends of the coil are electrically connected to the terminals formed on the outside of the layer of magnetic material and the semiconductor chip is mounted on the inductor element. The electrical connection between the semiconductor chip and the inductor element through the terminals reduces the distance between the two components and facilitates the mounting of the former on the latter. This helps realize the small-sized semiconductor module.

The inductor element should be placed on a mounting substrate. This helps realize the thin, small-sized semiconductor module.

The semiconductor chip should be placed on a mounting substrate which is electrically connected to the inductor element. This helps reduce the electrical connecting path between the mounting substrate and the inductor element while keeping the wiring capacity low.

Alternatively, the semiconductor chip should be placed on one side of the mounting substrate and the inductor element should be placed on the other side of the mounting substrate. This helps realize the thin, small-sized semiconductor module.

The inductor element should be mounted on a lead frame in such a way that it is above the semiconductor chip. This helps realize the thin, small-sized semiconductor module.

In production of the inductor element according to an embodiment of the present invention, the layer of magnetic material should be formed by aerosol deposition with a mask for openings through which the ends of the coil are exposed. Aerosol deposition in this manner permits the layer of magnetic material and the openings to be formed simultaneously.

Alternatively, the layer of magnetic material should be formed by aerosol deposition on the surface of the substrate of magnetic material and then it is fabricated to form openings through which the ends of the coil or any appropriate parts of the coil are exposed. This procedure permits the inductor element to have a previously fixed inductance or any desired inductance. By contrast, the above-mentioned procedure that employs a mask to form openings merely gives an inductor element which has a fixed inductance.

Aerosol deposition to form the layer of magnetic material should be accomplished by jetting out fine particles of magnetic material in the form of aerosol toward the substrate of magnetic material in such a way that the fine particles break as they impinge upon the surface of the substrate. Breakage creates activated surfaces that help bind the broken particles with the substrate as well as the broken particles together. This contributes to the layer of magnetic material having a compact structure.

The method for producing the inductor element should involve the steps of sequentially forming a titanium thin layer on the substrate of magnetic material, a copper thin layer on the titanium thin layer, and a copper plating layer on the copper thin layer, and subsequently forming the coil from the copper plating layer. The titanium thin layer in direct contact with the substrate permits the coil to firmly adhere to the substrate.

The terminals are formed in the openings through which both ends thereof or any desired parts thereof are exposed. The terminals of the coil permit the inductor element to be electrically connected to the semiconductor chip.

The embodiment of the present invention will be expounded with reference to the accompanying drawings.

The inductor element according to the embodiment mentioned hereunder is composed of a ferrite substrate (as the base), a copper inductor coil formed on the substrate, and a ferrite layer which is so formed by aerosol deposition as to enclose the inductor coil. According to the embodiment of the present invention, it is constructed such that the inductor coil is held between two layers of ferrite as a high-permeability magnetic material. This structure is favorable to the economical mass-production of the high-performance, thin, small-sized inductor element which has a high inductance and a high quality factor.

The copper wire constituting the inductor coil should be thicker than 50 μm and the ferrite layer on the inductor coil should also be thicker than 50 μm. With their thickness thus specified, they contribute to the inductor element having a high inductance and a high quality factor.

The high inductance is attributable to the ferrite material having a high permeability which encloses the inductor coil, and the high quality factor and low resistance are attributable to the inductor coil whose conductor has a large sectional area. The high inductance and high quality factor make the inductor element suitable for the high-performance module which contributes to the size reduction and improvement of electronic devices. The inductor element according to the present embodiment is preferably suitable for a module, for example, DC-DC converter, but is not limited to this.

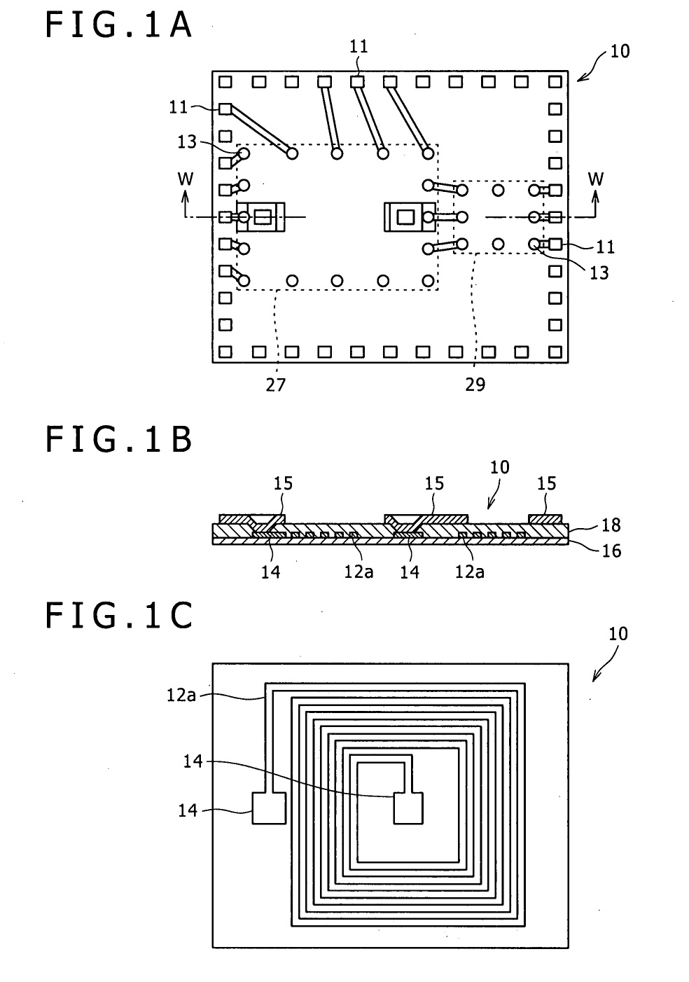

FIGs. 1A to 1C are schematic diagrams showing the structure of the inductor element 10 pertaining to the embodiment of the present invention. FIG. 1A is a plan view. FIG. 1B is a sectional view taken along the line W-W. FIG. 1C is a plan view showing the pattern of the inner layer (or coil) 12a of the inductor element.

As shown in FIG. 1B, the inductor element 10 is composed of a ferrite substrate 16, an inductor coil 12a in a spiral pattern formed on the ferrite substrate 16, and a ferrite layer 18 which is so formed on the ferrite substrate 16 as to enclose the inductor coil 12a.

The ferrite layer 18 has two openings through which coil terminals 14 are exposed at both ends of the coil. The coil terminals 14 which are exposed through the openings are electrically connected to a wiring pattern 15 formed on the inductor element 10. The wiring pattern 15 includes the wiring to electrically connect device A and device B together through electrode pads 13 formed at their respective mounting positions 27 and 29, the wiring to electrically connect the electrode pads 13 to the coil terminals 14, and the wiring to connect the electrode pads 13 to connecting terminals 11 for external connection or relaying. The electrode pads 13 are formed at positions conforming to the mounting terminals (such as bump terminals) for device A and device B.

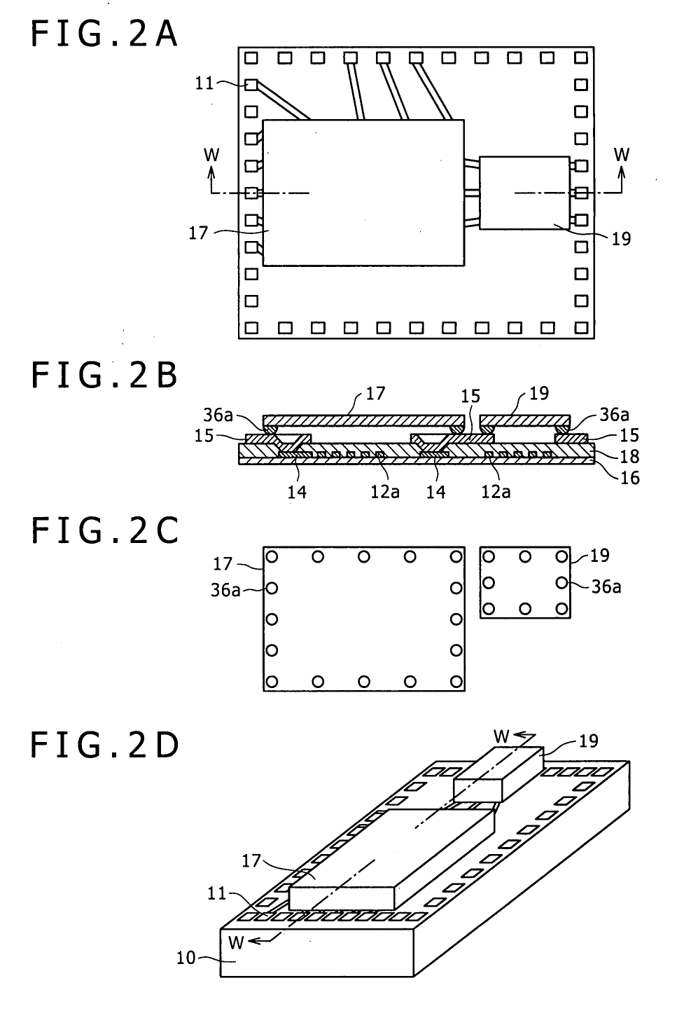

FIGS. 2A to 2D are schematic diagrams showing the inductor element 10 on which device A 17 and device B 19 are mounted according to the embodiment of the present invention. FIG. 2A is a plan view. FIG. 2B is a sectional view taken along the line W-W. FIG. 2C is a bottom view of device A 17 and device B 19 mounted on the inductor element 10. FIG. 2D) is a perspective view.

As shown in FIGS. 2A to 2D, device A 17 and device B 19 are connected to the inductor element 10 through solder bumps 36a by flip chip bonding for minimum path. According to the present embodiment, the combination of the inductor element 10 having a high inductance and a high quality factor and the devices mounted directly thereon leads to the semiconductor module which is thin and small in size. The inductor element is produced in the following manner.

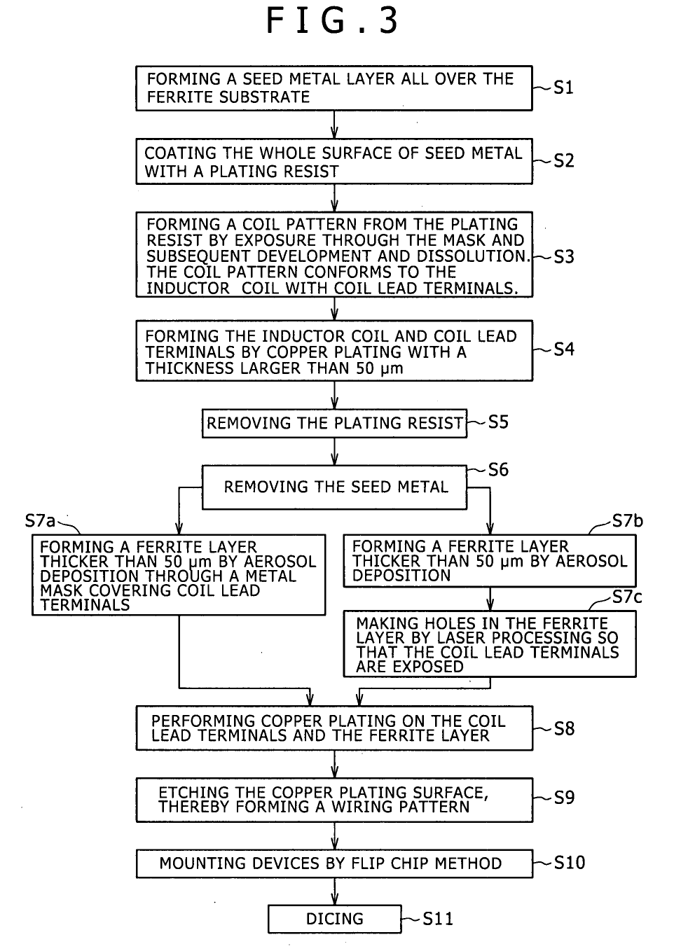

FIG. 3 is a flow sheet showing the steps of producing the inductor element and the semiconductor module according to the embodiment of the present invention.

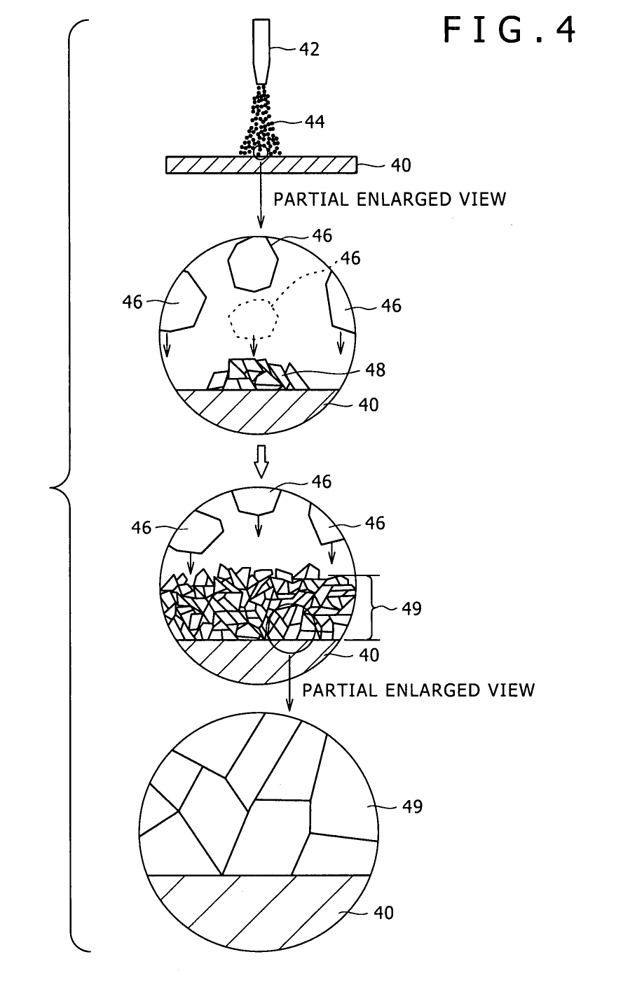

FIG. 4 is a flow sheet showing the film-forming steps by aerosol deposition according to the embodiment of the present invention.

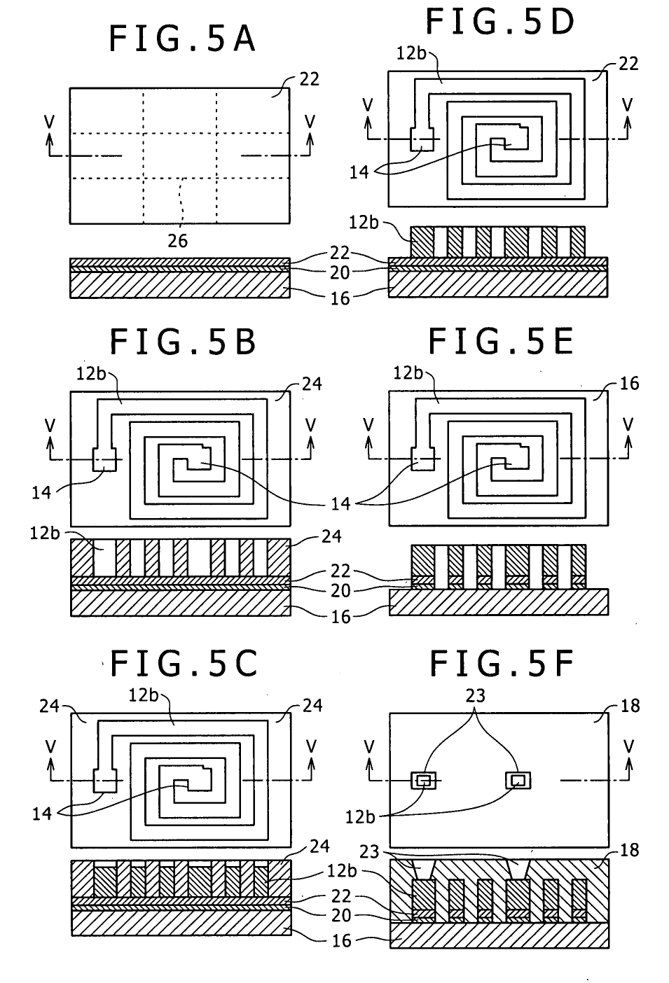

FIGS. 5A to 5F are diagrams showing the first half of the steps of producing the inductor element and the semiconductor module according to the embodiment of the present invention.

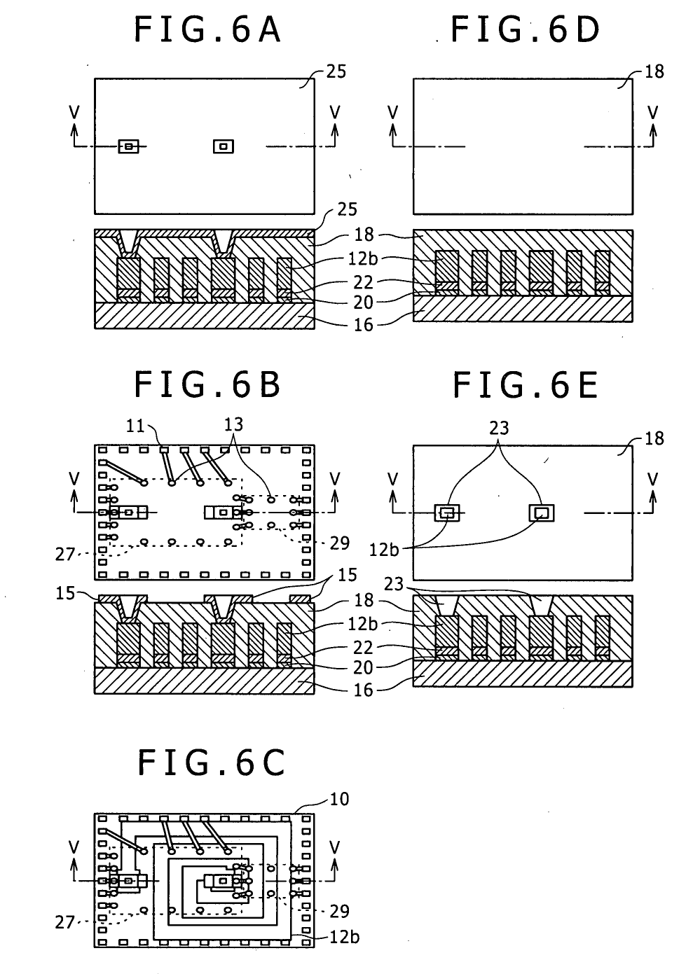

FIGS. 6A to 6E are diagrams showing the second half of the steps of producing the inductor element and the semiconductor module according to the embodiment of the present invention.

The steps S1 to S11 shown in FIG. 3 will be described with reference FIGS. 4 to 6A to 6E.

The step S1 is a step of forming a seed metal layer over the entire surface of the ferrite substrate.

In the step S1, the ferrite substrate 16 having desired dimensions is coated with a seed metal layer on which the coil pattern is to be formed, as shown in FIG. 5A. The seed metal layer is composed of the titanium layer 20 (0.1 μm thick) and the copper layer 22 (0.5 μm thick) which are sequentially formed by sputtering on the ferrite substrate 16. In the subsequent steps mentioned later, more than one inductor elements are formed in their respective regions 26 partitioned on the ferrite substrate 16. Incidentally, FIGS. 5B to 5F and FIGS. 6A to 6E show one inductor element formed in one of the regions 26. The process according to the embodiment of the present invention permits the inductor element to be produced economically and efficiently in the level of wafer fabrication.

The step S2 is a step of applying a plating resist onto the entire surface of the seed metal copper layer (the titanium layer 20 and the copper layer 22).

In the step S2, the copper layer 22 constituting the seed metal layer is entirely coated with the plating resist 24 in preparation for the coil pattern 12b.

The step S3 is a step of exposing through the mask, developing, and dissolving the plating resist.

In the step S3, the plating resist undergoes exposure through the mask, development, and dissolution, as shown in FIG. 5B, so that the part where the coil pattern 12b is to be formed is opened. Incidentally, the coil pattern 12b shown in FIGS. 5A and 6E has a less number of turns than that shown in FIG. 1 for the sake of brevity.

The step S4 is a step of performing copper plating thicker than 50 μm, thereby forming the inductor coil and the coil leads.

In the step S4, the inductor coil pattern 12b and the coil lead terminals (electrodes) 14 at both ends thereof are formed by electrolytic copper plating thicker than 50 μm, with a voltage applied to the seed metal, as shown in FIG. 5C.

The step S5 is a step of removing the plating resist.

In the step S5, the plating resist 24 is removed, so that the inductor coil pattern 12b and the coil lead terminals 14 remain on the surface of the copper layer 22 as the seed metal, as shown in FIG. 5D.

The step S6 is a step of removing the seed metal by etching.

In the step S6, etching is performed to remove the unnecessary part of the seed metal (composed of the titanium layer 20 and the copper layer 22) under the inductor coil pattern 12b and the coil lead terminals 14, as shown in FIG. 5E. Thus, the inductor coil pattern 12b and the coil lead terminals 14 are formed in each of the regions 26 which form a plurality of inductor elements on the ferrite substrate 16.

In the subsequent step, the ferrite layer that encloses the coil pattern 12b is formed on the ferrite substrate by aerosol deposition. Forming the ferrite layer or the magnetic layer of high-permeability material by aerosol deposition constitutes the feature of the embodiment of the present invention. The method of aerosol deposition is outlined in the following.

Aerosol deposition is a method of forming a thick film on a substrate from fine particles of functional magnetic material by spraying from a nozzle in the form of aerosol. It gives a thick film at low temperatures, without requiring baking at high temperatures (about 900 to 1600° C.) unlike the LTCC (Low-Temperature Co-fired Ceramic) method.

Aerosol deposition employs an apparatus forming of an aerosol generating unit (which changes fine particles of raw material into an aerosol form) and a spraying unit (which sprays fine particles in the aerosol form onto the substrate to form a film thereon). The aerosol generating unit has a gas cylinder and a flow meter connected thereto. The gas cylinder supplies a high-pressure carrier gas (such inert gas as argon, helium, neon, and nitrogen) and the flow meter controls the flow rate of the carrier gas, thereby regulating the amount of fine particles to be introduced into the aerosol and the amount of the aerosol to be sprayed. The aerosol generating unit also has a vibrator (to generate vibration mechanically, electromagnetically, or ultrasonically) which produces primary particles essential for the compact uniform film.

The spraying unit has an evacuating section connected thereto, which keeps the inside at a negative pressure. It also has a nozzle connected to the aerosol generating unit through a piping. Opposite the nozzle is a holder on which the substrate is placed. There are auxiliary mechanisms to move the substrate in XYZ directions and to change the nozzle direction and there is also a mask to define the regions in which films are formed by aerosol deposition.

To perform aerosol deposition, the aerosol generating unit is filled with fine particles of raw material having an average particle diameter of 10 nm to 2 μm and the spraying unit is supplied with argon as a carrier gas at 20 to 50 Pa, so that the fine particles are made into aerosol by mixing and vibration with the help of the vibrator. The fine particles in the form of aerosol are fed together with the carrier gas from the aerosol generator to the spraying unit which is kept at a lower pressure than the aerosol generator through a piping. The nozzle ejects the fine particles together with the carrier gas at a high speed, and the resulting jet stream deposits the fine particles on the substrate and forms the desired film. The speed of spraying should be properly controlled by the pressure of the carrier gas and the difference between the pressure in the aerosol generating unit and the pressure in the spraying unit. An adequate speed of spraying is 100 to 500 m/s. Spraying under this condition forms a film firmly adhering to the substrate.

Aerosol deposition is schematically shown in FIG. 4. The nozzle 42 ejects the stream 44 of fine particles in the form of aerosol at a high speed, which impinges upon the substrate 40. The fine particles that impinge upon the substrate 40 clean and activate the surface of the substrate 40 by removing contaminants and moisture. Moreover, the fine particles 46 are broken into minute fragments 48 (about 10 to 30 nm in size) having activated surfaces as they impinge upon the substrate 40 and they collide with one another. The resulting minute fragments 48 stick together on the surface of the substrate 40, forming a compact film 49 which firmly adheres to the substrate 40.

Aerosol deposition according to this embodiment is accomplished in such a way that fine particles of ferrite magnetic material are dispersed into a carrier gas and the resulting aerosol is sprayed onto the surface of a ferrite substrate so that the magnetic fine particles impinge upon the substrate. The magnetic fine particles impinging upon the substrate are broken into minute fragments which combine with one another and with the substrate, thereby forming a film firmly adhering to the substrate. The advantage of aerosol deposition is the ability to form the magnetic layer rapidly, economically, and reliably. The film forming rate achieved by aerosol deposition is 10 μm/min or above, which is greater than that of plating and sputtering.

The fine particles of raw material used to form the film in this embodiment are NiZn ferrite powder having an average particle diameter of 10 nm to 2 μm. The ferrite layer on the inductor coil should be thicker than 50 μm so that it exhibits desirable electrical properties.

Aerosol deposition to form the magnetic layer may be accomplished by way of the step S7a or the steps S7b and 7c, which are described in the following.

The step S7a is a step of forming the ferrite layer (thicker than 50 μm) by aerosol deposition that employs a metal mask covering the coil lead terminals.

In the step S7a, aerosol deposition is carried out through a metal mask (not shown) which is placed at the position where the opening 23 is formed for the coil lead terminal 14 to be exposed, as shown in FIG. 5F. In other words, aerosol deposition in this manner gives a patterned ferrite layer 18. The masked region is left uncoated, so that the opening 23 for the coil lead terminal 14 is exposed.

The step S7b is a step of forming the ferrite layer thicker than 50 μm.

In the step S7b, aerosol deposition is performed without any mask as shown in FIG. 6D, so that the ferrite layer 18 is formed on the inductor coil pattern 12b including the coil lead terminals 14 and the exposed part of the ferrite substrate 16, which are shown in FIG. 5E.

The step S7c is a step of laser processing to partly remove the ferrite layer where the coil lead terminals are to be exposed.

In the step S7c, the ferrite layer 18 formed in the step S7b undergoes laser processing to make the opening 23 for the coil lead terminals 14 to be exposed, as shown in FIG. 6E.

The step S8 is a step of copper plating on the ferrite layer and the coil lead terminals.

In the step S8, the ferrite layer 18 in which the opening 23 has been formed as shown in FIG. 5F or FIG. 6E is coated with the copper plating layer 25, as shown in FIG. 6A. The copper plating layer 25 has via holes formed at the openings 23 in the ferrite layer 18. These via holes are used for electrical connection of the coil lead terminals 14 to external electrodes.

The step S9 is a step of etching the copper plating layer, thereby forming the wiring pattern.

In the step S9, the copper plating layer 25, which has been formed in the step S8, undergoes etching to form the wiring pattern 15 as the top layer as shown in FIG. 6B. Incidentally, the wiring pattern 15 superimposed on the coil pattern 12b is shown in FIG. 6C.

The above-mentioned steps are all necessary to form the inductor elements on a wafer.

Mass production of the inductor elements (with devices mounted thereon) is accomplished by the steps S10 and S11 described in the following. The step S10 may be skipped if inductor elements without devices are to be produced.

The step S10 is a step of mounting devices by flip chip method.

In the step S10, each of the inductor elements formed in the divided regions 26 on the ferrite substrate 16 has devices such as semiconductor chips mounted thereon by flip chip method.

The step S11 is a step of separating individual semiconductor modules.

In the step S11, the regions 26 on which the inductor elements having the device mounted thereon are cut apart by using a precision machine. Thus there are obtained separated semiconductor modules. Finally, they are mounted on a printed circuit board, lead frame, or flexible wiring board.

In the embodiment mentioned above with reference to FIGS. 5A and 6E, a ferrite substrate thicker than 0.3 mm is used for easy handling. However, it is possible to reduce the thickness further by grinding the reverse side of substrate (down to a thickness of about 0.1 mm) after the step S9 or after the inductor element has been formed.

Incidentally, the embodiment mentioned above with reference to FIGS. 5A and 6E may employ a thin ferrite substrate having the thickness of 50 μm to 0.1 mm. In this case, the substrate 16 should be bonded to a supporter with a binder while it undergoes the above-mentioned steps. The supporter should be one which is resistant to the processing environment and the binder should be one which is easily removed after curing.

The foregoing is the method for producing the inductor element and semiconductor module having the inductor element and the devices mounted thereon.

The inductor element produced according to the embodiment of the present invention exhibits the following performance.

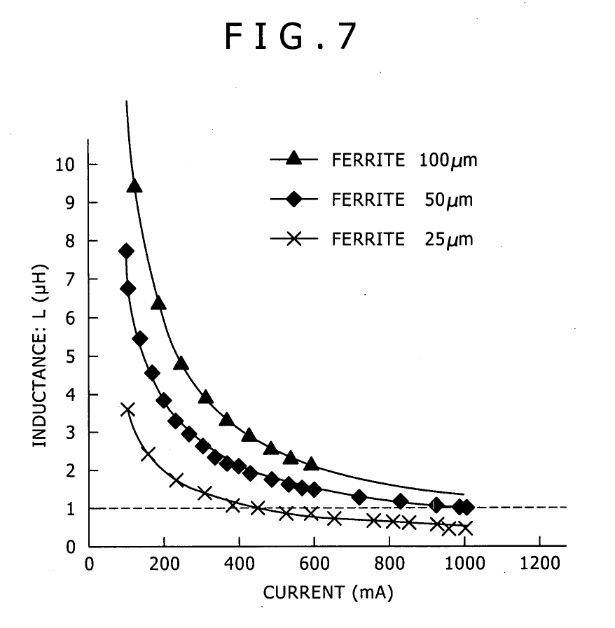

FIG. 7 is a graph showing the relation between the thickness and the inductance of the ferrite layer of the inductor element according to the embodiment of the present invention.

The data shown in FIG. 7 are based on experiments with the inductor element having the NiZn ferrite substrate 16 with an area of 5.4 mm², a thickness of 100 μm, and density of 4.8 g/cm³ and a three-turn copper spiral coil with a conductor width of 60 μm, a conductor thickness of 50 μm, and a conductor gap of 25 μm. The NiZn ferrite has a composition of (Ni,Zn)Fe₂O₄.

The ferrite layer 18 is formed by aerosol deposition from fine particles of NiZn ferrite. It has the same area as the ferrite substrate, and it also has a thickness of 25 μm, 50 μm, or 100 μm. The thickness is measured from the top of the copper conductor of the coil. The NiZn ferrite has a permeability of 1000 H/m.

The inductance L of the inductor element is obtained by the formula below, in which i denotes current and V denotes induced electromotive force.

L=V·dt/di

The inductor elements with the ferrite layer varying in thickness as mentioned above were tested for inductance while current flowing through the coil was varied in the range of about 100 mA to about 1 A. The results are shown in FIG. 7.

The foregoing result suggests that the ferrite layer and the ferrite substrate should be thicker than 50 μm if the inductor element measuring 2.5 mm square is to have an inductance of 1 μH and a maximum allowable current of 1 A.

This result also indicates that the inductor element measuring 2.5 mm square and having an inductance of about 1 μH and an allowable current of about 1A could be as thin as 150 μm.

Needles to say, the same desirable values as mentioned above will be obtained even though the inductor element is varied in dimensions, allowable current, and inductance and the magnetic substrate and the layer of magnetic material are formed from any other material than NiZn ferrite as the high-permeability material.

The semiconductor module is constructed as explained in the following.

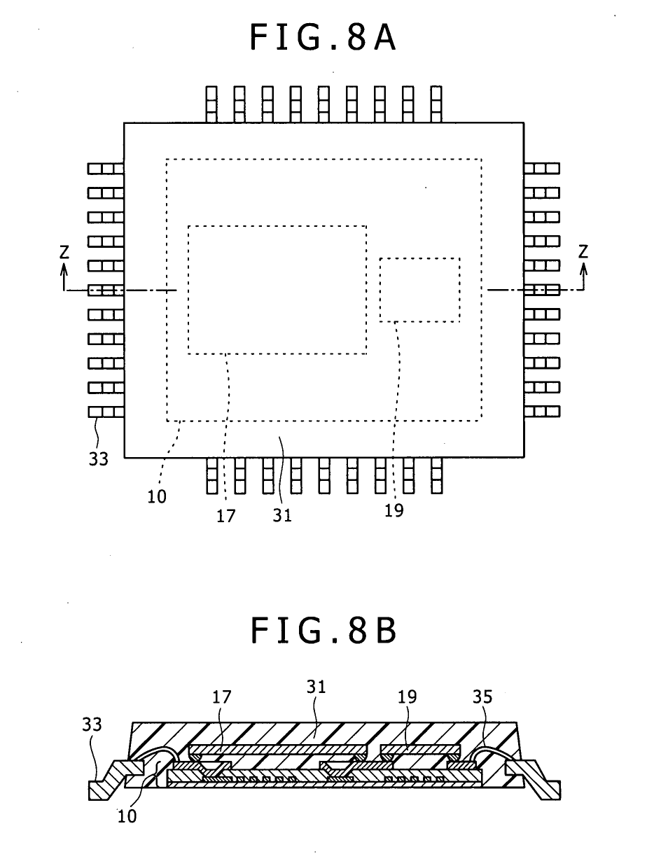

FIG. 8 is a diagram showing the structure of the module according to the embodiment of the present invention. The module is composed of the inductor element 10 and the devices 17 and 19 mounted thereon, with the former being connected to the lead frame 33. FIG. 8A is a plan view, and FIG. 8B is a sectional view taken along the line Z-Z.

The process of producing the module starts after the inductor elements at a wafer level have been formed as shown in FIG. 6B. The first step is to mount the device A 17 and the device B 19 by flip chip method on each of the inductor elements 10 formed on the individual regions in the ferrite substrate 16. Incidentally, the devices A 17 and B 19 have previously formed bumps for connecting terminals.

There is no need for new wiring for the devices A 17 and B 19 because the wiring pattern 15 on the inductor element 10 has the pads 13 corresponding to the connecting terminals of the devices A 17 and B 19. After dicing, each inductor element 10 with the devices mounted thereon is electrically connected to the lead frame 33 by wire bonding 35. Finally, the assembly is shielded with the molding resin 31 by transfer molding. Thus there is obtained the integrated semiconductor module having the inductor element and other chips. Incidentally, although the devices A 17 and B 19 have bumps formed by printing with solder paste, bumps may be formed in any other ways from any other materials.

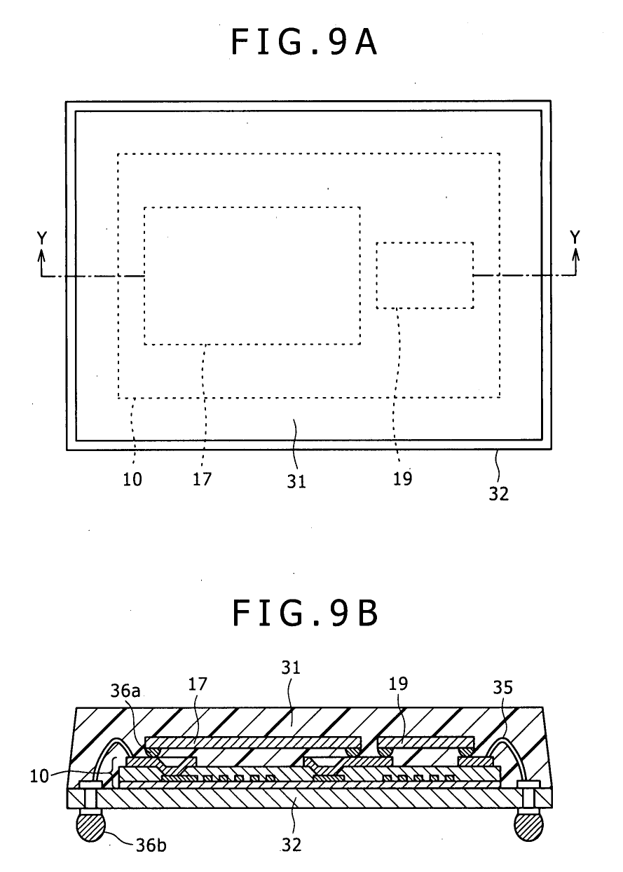

FIGS. 9A and 9B are diagrams showing the structure of the module consisting of the interposer substrate 32 and the inductor element 10 arranged thereon, the latter having the device 17 and 19 mounted thereon, according to the embodiment of the present invention. FIG. 9A is a plan view and FIG. 9B is a sectional view taken along the line Y-Y.

As FIGS. 9A and 9B show, the inductor element 10 with the devices 17 and 19 mounted thereon by means of the solder bump 36b is attached by die bonding to the interposer substrate 32 with the solder bump 36b arranged thereon, and they are sealed with the mold resin 31 for integration into a module.

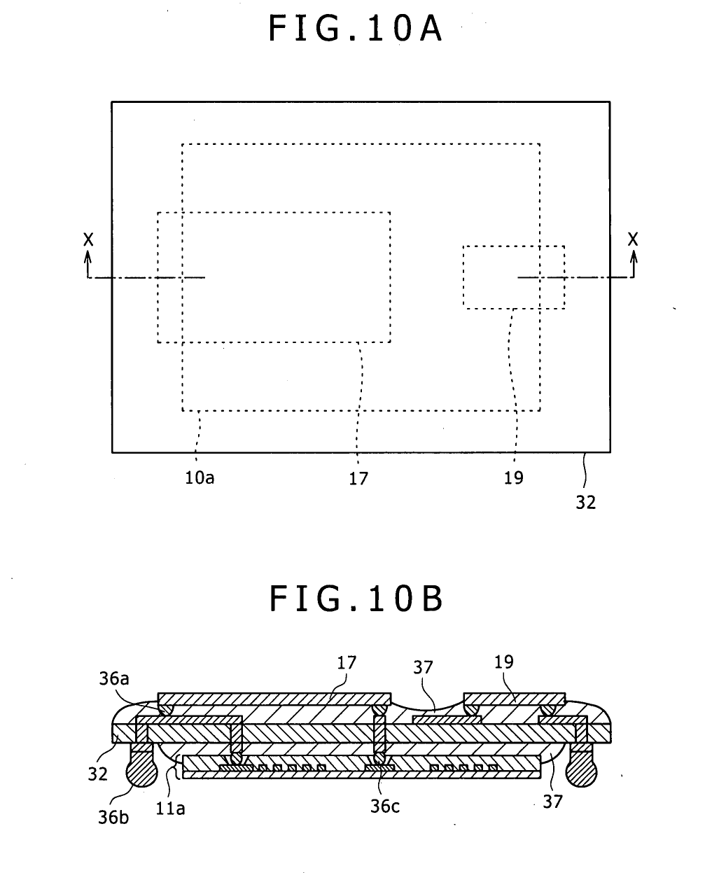

FIGS. 10A and 10B are diagrams showing the structure of the module in which the interposer substrate 32 supports thereon and thereunder the devices 17 and 19 and the inductor element 10, respectively according to the embodiment of the present invention. FIG. 10A is a plan view, and FIG. 10B is a sectional view taken along with the line X-X.

As FIGS. 10A and 10B show, the module is composed of the interpose substrate 32 of organic material and the device 17 and 19 directly mounted thereon and the inductor element 10a directly mounted thereunder. They are fixed and sealed with the underfill material 37 for integration. The coil terminal 14 of the inductor element 10a and the devices 17 and 19 are electrically connected to the wiring part of the interposer substrate 32 through the solder bump 36c and the solder bump 36a, respectively.

The inductor element 10a shown in FIGS. 10A and 10B, unlike the inductor element 19 shown in FIGS. 8A and 8B and 9A and 9B, has the wiring pattern 15 omitted for its thickness reduction and has its coil terminal of the interposer substrate 32. The structure shown in FIGS. 10A and 10B may be modified such that the inductor element 10a is replaced by the inductor element 10 shown in FIGS. 8A and 8B and 9A and 9B, as a matter of course.

The structure of the module mentioned above is merely exemplary; the constituents of the module may be connected and mounted in any manner.

The substrate with an inductor element mounted thereon according to the existing technology does not permit a large-capacity inductor to be formed thereon because the layers for multilayer wiring is partly used to form the coil. It is also limited in metallic material and thickness because the coil is formed according to the specification common to the wiring pattern on the substrate. There disadvantages inherent in the existing technology do not exist in the embodiment of the present invention in which the inductor element is formed independently as a single element without any restrictions on material and structure. Consequently, the inductor element according to the embodiment of the present invention exhibits the maximum performance that can be derived from the characteristic properties of the material and structure mentioned above. That is, it has a large inductance because the inductor soil is embedded in and held between the ferrite material having a high permeability. The fact that the inductor element has formed thereon leas terminals and wiring leasing to electrode terminals for connection to desired devices is the reason why the inductor element can support any desired device thereon and more than one device can be integrated into on package which leads to miniaturization.

The inductor element according to the embodiment of the present invention differs in structure from the one described in Non-Patent Document 1. The former has a compact ferrite magnetic layer (with a high permeability) which fills gaps between coil conductors and encloses the conductor coil entirely, whereas the latter merely has a mixture of ferrite powder and resin which fills gaps between coil conductors. This difference in structure leads to a high inductance.

The process according to the embodiment of the present invention, which resorts to aerosol deposition to form the ferrite layer, offers the advantage of being able to form the ferrite layer more rapidly than the wet plating method disclosed in Patent Document 1.

While a preferred embodiment has been described above, variations thereto will be made as follows within the scope of the present invention.

It is possible to change the thickness and dimensions of the magnetic substrate and the magnetic layer and the metallic material constituting the coil conductor, so that the resulting inductor element has a desired inductance and quality factor.

The magnetic substrate and the magnetic layer are typically formed from ferrite which is a compound oxide having a high electrical resistance and containing trivalent iron ions; however, they may also be formed from MnZn ferrite (spinel-type ferrite), MgMn ferrite, or NiZnCu ferrite, which has a high permeability. The ferrite substrate may be a sintered plate or a single-crystal plate or a ferrite layer formed by aerosol deposition on an insulating substrate thinner than 200 μm of ceramics or the like. Needless to say, they may be formed from any other high-permeability materials than spinel-type ferrite as a magnetic substrate and magnetic layer so long as they have a high electrical resistance.

The coil may be formed by any other methods than copper plating, such as well-known screen printing with a conductive paste of silver, copper, or gold. In addition, the wiring pattern 15 may be formed by vapor deposition or sputtering.

The coil is not limited to the planar coil. It may be composed of two spiral coils formed on both sides of the ferrite substrate 16 and connected to each other through holes made in the ferrite substrate 16. The spiral coils are enclosed by the ferrite layers 18 formed on both sides of the ferrite substrate 16.

Aerosol deposition to form the layer of magnetic material can be carried out under optimum conditions previously established by experiments. Such conditions include the size of fine particles as raw material, the properties of aerosol, the speed of aerosol spraying, and the temperature of the substrate on which the layer of magnetic material is formed.

1. An inductor element comprising:
a substrate of magnetic material;
a coil of conductive material formed on said substrate; and
a layer of magnetic material which is so formed by aerosol deposition as to enclose said coil on said substrate.

2. The inductor element as defined in claim 1, wherein the substrate of magnetic material is formed from a high-permeability material.

3. The inductor element as defined in claim 1, wherein the layer of magnetic material is formed from a high-permeability material.

4. The inductor element as defined in claim 1, wherein the substrate of magnetic material is formed from ferrite.

5. The inductor element as defined in claim 1, wherein the layer of magnetic material is formed from ferrite.

6. The inductor element as defined in claim 5, wherein the ferrite has a thickness larger than 50 μm.

7. The inductor element as defined in claim 1, wherein the coil is a planar coil.

8. The inductor element as defined in claim 7, wherein the planar coil has a thickness larger than 50 μm.

9. The inductor element as defined in claim 1,
wherein the coil has the terminals connected to both ends which are formed on the outside of the layer of magnetic material.

10. The inductor element as defined in claim 1, wherein the substrate of magnetic material has a thin titanium layer and a thin copper layer which are sequentially formed on said titanium layer, and the coil is formed from a copper plating layer as said conductive layer which is formed on said thin copper layer.

11. The inductor element of claim 1, comprising:
a semiconductor module, the inductor element secured within the semiconductor module and a semiconductor chip electrically connected to the inductor element.

12. The semiconductor module as defined in claim 11, wherein both terminals of the coil are electrically connected to the terminals formed on the outside of the layer of magnetic material and the semiconductor chip is mounted on the inductor element.

13. The semiconductor module as defined in claim 11, wherein the inductor element is arranged on a mounting board.

14. The semiconductor module as defined in claim 11,
wherein the semiconductor chip is arranged on a mounting board and the inductor element is electrically connected to the mounting board.

15. The semiconductor module as defined in claim 14,
wherein the semiconductor chip is arranged on one side of the mounting board and the inductor element is arranged on the other side of the mounting board.

16. The semiconductor module as defined in claim 11,
wherein the inductor element is mounted on a lead frame.

17. A method for producing an inductor element comprising the steps of:
forming a coil from a conductive material on a substrate of magnetic material; and
forming by aerosol deposition a layer of magnetic material so as to enclose said coil on said substrate.

18. The method for producing an inductor element as defined in claim 17,
wherein the step of forming the layer of magnetic material by aerosol deposition employs a mask which leaves openings through which both ends of the coil of the inductor element are exposed.

19. The method for producing an inductor element as defined in claim 17,
wherein the layer of magnetic material is formed by aerosol deposition on the substrate of magnetic material and subsequently the layer of magnetic material is fabricated to make openings through which both ends or any desirable parts of the coil are exposed.

20. The method for producing an inductor element as defined in claim 17,
wherein to form the layer of magnetic material is accomplished by jetting out fine particles of magnetic material in the form of aerosol toward the substrate of magnetic material in such a way that the fine particles break as they impinge upon the surface of the substrate and breakage creates activated surfaces that help bind the broken particles with the substrate of magnetic material and the broken particles together.

21. The method for producing an inductor element as defined in claim 17, comprising the steps of:
forming a titanium thin layer on the substrate of magnetic material;
forming a copper thin layer on the titanium thin layer;
forming a copper plating layer on the copper thin layer as the conductive material; and
forming the coil from the copper plating layer.

22. The method for producing an inductor element as defined in claim 18,
wherein the openings are formed at both ends of the coil and terminals are formed in these openings.

23. The method for producing an inductor element as defined in claim 19,
wherein the openings are formed at both ends of the coil and terminals are formed in these openings.
